(19) United States
(12) Patent Application Publication
(10) Pub. No.: US 2005/0114150 A1
(43) Pub. Date: May 26, 2005

(54) Dining preferences storage mechanism

(75) Inventor: Brent David Franklin, Round Rock, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/718,095

(22) Filed: Nov. 20, 2003

(51) Int. Cl. G06F 17/60

(52) U.S. Cl. 705/1

(57) ABSTRACT

A storage device for dining preferences. The storage device includes a card, a memory, and a communications interface. The memory is located within the card. The memory stores a plurality of dining preferences for at least one restaurant. The dining preferences are portable from location to location and are capable of repetitious use. The communications interface allows for the dining preferences to be read from the memory by a data processing system at a restaurant for use in generating a food order.

### BACKGROUND OF THE INVENTION

1. Technical Field

The present invention relates generally to an improved data processing system and in particular to a method and apparatus for processing data. Still more particularly, the present invention relates to a method, apparatus, and computer instructions for managing user preferences with respect to food orders.

2. Description of Related Art

In today's times, most people eat out at restaurants on a regular basis. In fact, many people eat out one or more times each week. When going to restaurants, especially fast food restaurants, the user selects different food items from a menu. In many cases, the user may alter the ingredients within a particular food item based on the user's preferences. In doing so, the user must recite or tell the restaurant employee their preferences on how they would like their food prepared. This communication of preferences is repeated each time an order is made even though the preferences may never change. If the preferences are lengthy or if the employee at the restaurant is in a hurry, some or all of the preferences may not be successfully recorded and fulfilled as desired by the user.

Additionally, some restaurants allow a customer to watch the preparation of the food. Before each ingredient is added, the customer may be asked if that ingredient is desired. This type of preparation is commonplace in sandwich restaurants. The customer preferences on how to build a particular meal generally do not change, but the customer must repeat them each time the customer orders food from the restaurant.

Therefore, it would be advantageous to have an improved method, apparatus, and computer instructions for communicating user preferences for food items.

### SUMMARY OF THE INVENTION

The present invention provides a storage device for dining preferences. The storage device includes a card, a memory, and a communications interface. The memory is located within the card. The memory stores a plurality of dining preferences for at least one restaurant. The dining preferences are portable from location to location and are capable of repetitious use. The communications interface allows for the dining preferences to be read from the memory by a data processing system at a restaurant for use in generating a food order.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram illustrating a memory card in accordance with a preferred embodiment of the present invention;

FIG. 4 is a diagram illustrating components used in storing and transferring dining preferences in accordance with a preferred embodiment of the present invention;

FIG. 5 is a diagram illustrating an example of dining preferences in accordance with a preferred embodiment of the present invention;

FIG. 6 is a flowchart of a process for communicating preferences for food items in accordance with a preferred embodiment of the present invention;

FIG. 7 is a flowchart of a process for generating dining preferences in accordance with a preferred embodiment of the present invention; and

FIGS. 8A and 8B are diagrams of an interface for displaying preferences from a memory card in accordance with a preferred embodiment of the present invention.

### DETAILED DESCRIPTION OF THE PREFERRED EMBODIMENT

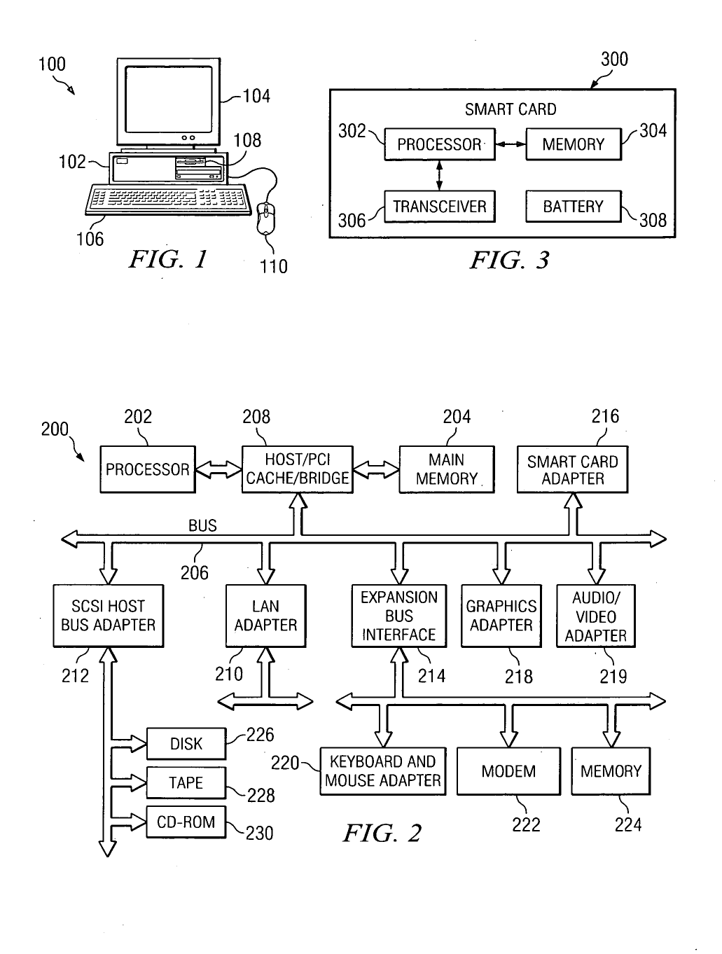

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, smart card adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

The present invention provides a method, apparatus, and computer instructions for communicating dining preferences of a customer to an establishment or business, such as a restaurant. A memory card or other storage device, such as a smart card, may be used to store preferences for various food items at one or more restaurants. This memory card is portable between different establishments.

In one illustrative example, when a customer orders food, the employee takes the card and transfers preferences for that particular restaurant into their order system. In this manner, preferences for a particular meal may be automatically added to the order. These preferences may be recorded in the memory card in any number of different ways. For example, the customer may tell the employee preferences once and have those preferences saved on the card by the employee at the restaurant. Alternatively, a terminal may be provided at a restaurant or at other locations located remotely from the restaurant to allow users to set preferences. Also, a customer may set preferences at home or elsewhere through the use of a card reader attached to a personal computer or laptop.

The programming may occur using an interface, such as a Web interface in which the preferences are selected through a user entering data into a Web page. Such an interface is especially useful if the programming of the memory card is performed using a kiosk that is located in a public location, such as a bus terminal or a shopping mall. A user may program a card for different restaurants.

With reference next to FIG. 3, a diagram illustrating a memory card is depicted in accordance with a preferred embodiment of the present invention. Smart card 300 is an example of one type of memory card that may be used to store user preferences for food items. These preferences include, for example, preferences for having or excluding certain items, such as mustard, tomatoes, mayonnaise, or cheese. Further, the preferences may include cooking preferences for meats, such as rare, medium, medium-well, and well done.

In this illustrative example, smart card 300 is a plastic card with embedded integrated circuits for storing this preference information. In particular, smart card 300 contains processor 302, memory card 304, and transceiver 306. Smart card 300 is portable and resembles a credit card, but contains additional circuitry to store and process information. An alternative form of a memory card that may be used is a magnetic dashed stripe card. Such a card may be used, but stores less information and has no processing capability.

In this example, user preferences may be stored in memory 304. These preferences may be accessed through processor 302. The transmission of the preferences is provided through transceiver 306. Transceiver 306 provides a contactless mechanism for transferring data. Such a system is less prone to errors than those types of smart cards requiring contact to transfer data. In this type of system, power is supplied to smart card 300 for processor 302 through battery 308. Transceiver 306 provides a communications interface to send and receive data. This type of transceiver may use RF signals or infrared signals depending on the type of implementation.

This communications interface is used to exchange data with a data processing system, such as data processing system 200 in FIG. 2. In particular, data may be exchanged through smart card adapter 216 in FIG. 2. The smart card adapter provides a reader and writer to support various card protocols to allow reading and writing data to smart cards. The data processing system may be, for example, a terminal at a restaurant, a home computer, or a kiosk.

Further, security protocols may be implemented using processor 302 to prevent writing data to memory 304 unless an appropriate key, such as a personal identification number (PIN) or certificate is received. In the illustrative examples, writing data to memory 304 is allowed without requiring entry of a key.

With respect to preferences stored in memory 304, smart card 300 stores dining preferences for one or more restaurants in this memory. These preferences may be used through all different restaurants within a particular chain. Further, preferences stored in smart card 300 may be configured outside of a restaurant to indicate dining preferences for the different restaurants.

Smart card 300 may be read by a cash register system with a card reader to display preferences and initiate processing of a food order with the desired preferences. As a result, portability of dining preferences is provided for a customer in which these dining preferences may be carried to different restaurants through smart card 300.

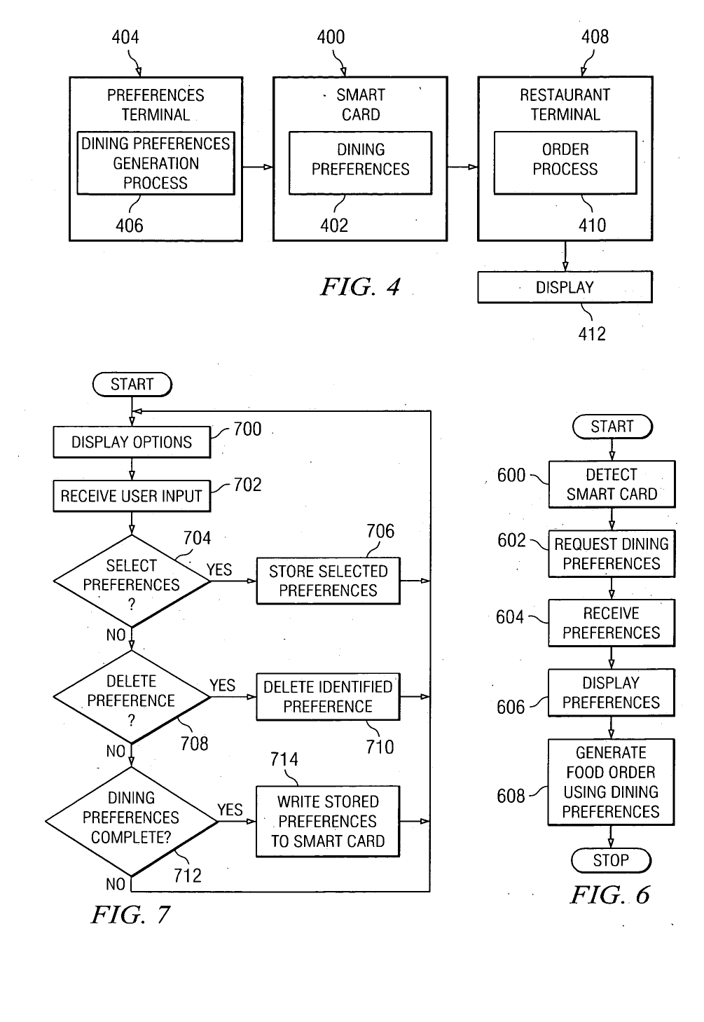

Turning now to FIG. 4, a diagram illustrating components used in storing and transferring dining preferences is depicted in accordance with a preferred embodiment of the present invention. Smart card 400 contains dining preferences 402. Smart card 400 may be implemented using a smart card, such as smart card 300 in FIG. 3.

Dining preferences 402 are written to smart card 400 using preferences terminal 404. Software, such as dining preferences generation process 406 is used to write the data to smart card 400. Preferences terminal 404 may be implemented using a data processing system, such as data processing system 200 in FIG. 2.

Preferences terminal 404 may be located in various locations, depending on the particular implementation. For example, preferences terminal 404 may take the form of a personal computer at the home of the customer or may be a kiosk in a mall or restaurant. Smart card 400 may be programmed at preference terminal 404 with preferences that may be used at a number of different restaurants, making these preferences portable for the user.

In these illustrative examples, the preferences may be entered by the customer. In another embodiment, preferences terminal 400 may be part of a food ordering system operated by an employee. In such a case, the employee may enter preferences for the user.

Dining preferences 402 may then be read at a later point in time by restaurant terminal 408. In particular, order process 410 is software that is used to receive dining preferences 402 from smart card 400. Restaurant terminal 408 may be implemented using a data processing system, such as data processing system 200 in FIG. 2.

When dining preferences 402 are obtained by order process 410, these preferences may be displayed on display 412. In this manner, the user and employee both can verify that the preferences are the ones that the customer desires for a particular food item or order. The food order may then be processed with the customer's particular dining preferences being taken into account. Dining preferences 402 may contain preferences for many different restaurants. In such a case, dining preferences 402 contains entries that may be identified in various ways, such as through a restaurant name, a meal name, or some other identifier along with the particular preferences for a particular meal or food item. As a result, smart card 400 is portable between different restaurants because smart card 400 is carried by the customer and preferences are stored in identification with a particular restaurant. Further, preferences programmed for a restaurant in one location may be used in restaurants in other locations that are part of the same chain in these illustrative examples.

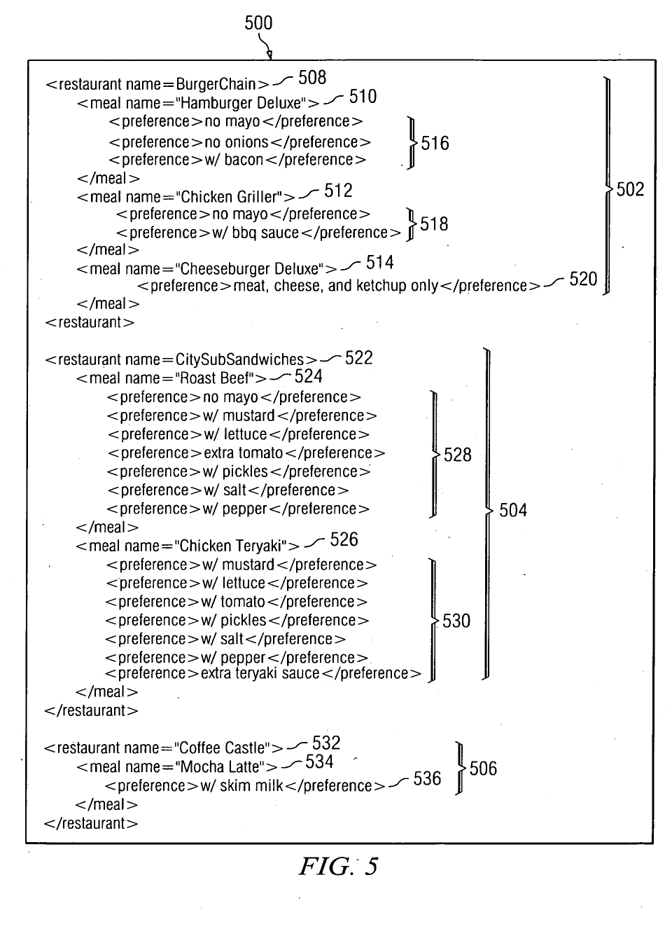

With reference now to FIG. 5, a diagram illustrating an example of dining preferences is depicted in accordance with a preferred embodiment of the present invention. Dining preferences 500 is an example of dining preferences, such as dining preferences 402 in FIG. 4 in this illustrative example. Dining preferences 500 is in an extensible mark up language (XML) format. Of course other types of schema or formats may be used depending on the particular implementation.

As illustrated, sections 502, 504, and 506 contain dining preferences for three different restaurants or establishments. In section 502, line 508 identifies the restaurant name as “BurgerChain”. Lines 510, 512, and 514 identify three food items for this particular establishment. Sections 516, 518, and 520 contain the preferences for these three food items.

Next, line 522 identifies a different restaurant stored in the preferences. In this case, the restaurant is “CitySubSandwiches”. Lines 524 and 526 identified two food items for this particular restaurant. The preferences for these food items are found in sections 528 and 530. Line 532 identifies a third restaurant for the user preferences. This restaurant is named “Coffee Castle”. The drink item is identified in line 534 with the preference for this drink item being specified in line 536.

Turning now to FIG. 6, a flowchart of process for communicating preferences for food items is depicted in accordance with the preferred embodiment of the present invention. The process illustrated in FIG. 6 may be implemented in a restaurant order process, such as order process 410 in FIG. 4.

The process begins by detecting a smart card (step 600). The smart card may be detected by contact with a card reader or through the smart card being within a selected proximity of the card reader. Dining preferences are requested from the smart card (step 602). These dining preferences are received from the smart card (step 604). Thereafter, the preferences are displayed (step 606). This step displays the preferences and allows the customer and employee to verify that the preferences for a particular food order are correct. Thereafter, the food order is generated using the dining preferences (step 608) with the process terminating thereafter.

Turning now to FIG. 7, a flowchart of process for generating dining preferences is depicted in accordance with a preferred embodiment of the present invention. The process illustrated in FIG. 7 may be implemented in a process, such as dining preferences generation process 406 in FIG. 4.

The process begins by displaying options (step 700). These options allow the user to create and edit dining preferences for different restaurants. A user input is received (step 702). A determination is then made as to whether the user input selects a preference (step 704). If a preference for a food item is selected, that preference is stored (step 706) with the process then returning to step 700.

In these illustrative examples, these preferences are for different preferences for food items. For example, a user may enter or select a preference, such as no mayonnaise, no ketchup, no pickles, and/or medium well. The different preferences that may be selected depend on the particular food item for which preferences are being generated.

With reference again to step 704, if the user input does not select a preference, then a determination is made as to whether user input selects an option to delete a preference (step 708). The user may wish to delete a preference that has just been selected or entered or change a previous preference. For example, previously, the user may have entered no tomatoes, but at this time has decided that tomatoes are desirable for a particular food item. If the delete preference has been selected, the identified preference is deleted (step 710) with the process then returning to step 700.

With reference again to step 708, if the user input does not delete a preference, then a determination is made as to whether the user input selects an option indicating that the dining preferences are complete (step 712). If the dining preferences are not complete, the process returns to step 700. Otherwise, the stored preferences are written to the smart card (step 714) with the process then returning to step 700.

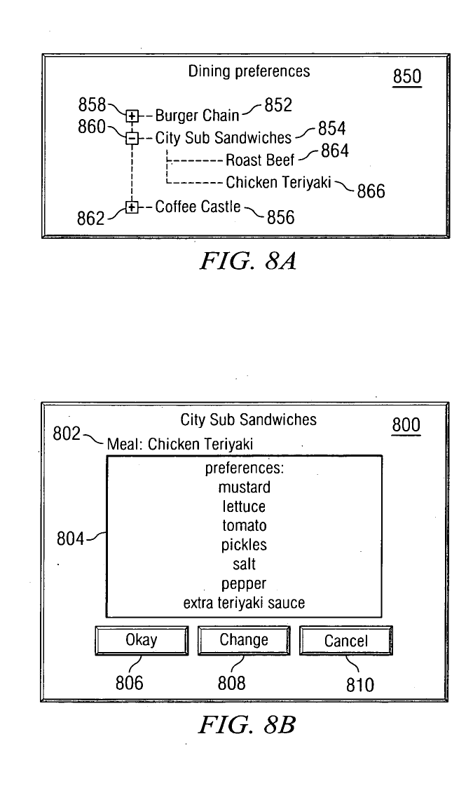

Turning next to FIGS. 8A and 8B, diagrams of an interface for displaying preferences from a memory card is depicted in accordance with a preferred embodiment of the present invention. Displays 800 and 850 are examples of displays that may be presented at a terminal, such as preferences terminal 404 in FIG. 4. This terminal may be located at different places, such as at a restaurant, in a public location, or at the user's home. Display 800 is presented when the memory card is read by the memory card reader at the terminal.

In FIG. 8A, display 850 is an example of an initial display of preferences stored on a memory card, such as a smart card. These dining preferences illustrate those from preferences 500 in FIG. 5. In display 850, three restaurants, Burger Chain 852, City Sub Sandwiches 854, and Coffee Castle 856, are shown. The preference information is displayed in a tree format in which additional information may be displayed by selecting indicators 858, 860, and 862. As can be seen, the following meals: roast beef 864 and chicken teriyaki 866 are displayed for City Sub Sandwiches 854 when indicator 860 is selected. A selection of the meal chicken teriyaki 866 results in a more detailed screen of the preferences for that meal being displayed.

In this illustrative example, in FIG. 8B, display 800 is for a restaurant called City Sub Sandwiches. In this example, the meal is for a chicken teriyaki sandwich as shown in line 802. This meal is displayed in response to a selection of chicken teriyaki 866 in display 850. Section 804 in display 800 contains preferences for a chicken teriyaki meal as stored in section 530 in preferences 500 in FIG. 5.

If the user is satisfied with the preferences, as shown in display 800, the user may select “Okay” button 806. If the terminal for display 800 is a cash register located at a restaurant, selection of this button causes an order to be generated using these preferences. If the user desires to change preferences, the user may select “Change” button 808. Selection of this button will allow the user to edit text within section 804 to add, delete, and/or change preferences. If the user wishes to cancel the transaction, the user may select “Cancel” button 810.

Thus, the present invention provides an improved method, apparatus, and computer instructions for generating and communicating dining preferences for a customer. The mechanism of the present invention stores dining preferences for one or more restaurants in a portable storage device, such as a smart card. In these examples, the preferences are communicated by the smart card to the ordering system of the particular restaurant for which a food item is desired. The portable storage device allows portability of the preferences from one restaurant to another restaurant. Preferences generated for one restaurant may be used in other restaurants in the same chain of restaurants. Further, preferences may be present for different restaurants.

In this manner, dining preferences for a user may be quickly and efficiently transmitted to a restaurant. In this manner, fewer errors are likely to be made in taking and filling food orders. Further, by transmitting these dining preferences using a smart card, the time needed for a user to verbally communicate the same dining preferences is avoided. As a result, ordering of food at a restaurant becomes more efficient and pleasant for customers.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A storage card for dining preferences, the storage card comprising:
a card;
a memory located within the card, wherein the memory stores a plurality of dining preferences for at least one restaurant, wherein the plurality of dining preferences are portable from location to location and are capable of repetitious use; and
a communications interface, wherein the communications interface allows for the dining preferences to be read from the memory by a data processing system at a restaurant for use in generating a food order.

2. The storage card of claim 1, wherein the storage card is a smart card.

3. The storage card of claim 1, wherein the communications interface uses radio frequency signals to read and write the dining preferences.

4. The storage card of claim 3, wherein the communications interface is a radio frequency transceiver.

5. The storage card of claim 1, wherein each of the plurality of dining preferences includes a name of a restaurant, a name of a food item, and preferences for the food item.

6. A method in a data processing system for using dining preferences to generate an order, the method comprising:
reading dining preferences for a restaurant from a memory in a card for a customer, wherein the memory includes dining preferences for food items for a set of restaurants;
displaying the dining preferences; and
generating the order using the dining preferences.

7. The method of claim 6, wherein the set of restaurants includes at least one restaurant.

8. The method of claim 6 further comprising:
initiating the generating step after a user input confirming the dining preferences for the order.

9. The method of claim 6, wherein the. card is a smart card.

10. The method of claim 6, wherein the dining preferences are read from the memory using radio frequency signals.

11. The method of claim 6, wherein the memory is one of a magnetic strip or a nonvolatile random access memory.

12. The method of claim 6., wherein the dining preferences are stored in association with a restaurant name and a food item name.

13. The method of claim 6, wherein the dining preferences for the restaurant are portable.

14. The method of claim 6, wherein the dining preferences are generated by at least one of a kiosk in a public location, a terminal at the restaurant, and a computer in a home of a user.

15. A data processing system in a data processing system for using dining preferences to generate an order, the data processing system comprising:
reading means for reading dining preferences for a restaurant from a memory in a card for a customer, wherein the memory includes dining preferences for food items for a set of restaurants;
displaying means for displaying the dining preferences; and
generating means for generating the order using the dining preferences.

16. The data processing system of claim 15, wherein the set of restaurants includes at least one restaurant.

17. The data processing system of claim 15 further comprising:
initiating means for initiating the generating means after a user input confirming the dining preferences for the order.

18. The data processing system of claim 15, wherein the card is a smart card.

19. A computer program product in a computer readable medium for using dining preferences to generate an order, the computer program product comprising:
first instructions for reading dining preferences for a restaurant from a memory in a card for a customer, wherein the memory includes dining preferences for food items for a set of restaurants;
second instructions for displaying the dining preferences; and
third instructions for generating the order using the dining preferences.

20. The computer program product of claim 19, wherein the set of restaurants includes at least one restaurant.

21. The computer program product of claim 19 further comprising:
fourth instructions for initiating the third instructions after a user input confirming the dining preferences for the order.

22. The computer program product of claim 19, wherein the card is a smart card.
